(19) United States
(12) Patent Application Publication
(10) Pub. No.: US 2013/0051567 A1
(43) Pub. Date: Feb. 28, 2013

(54) TAP DETECTION OF SOUND OUTPUT DEVICE

(71) Applicant: Kirk P Gipson, Roseville, CA (US)

(72) Inventor: Kirk P Gipson, Roseville, CA (US)

(21) Appl. No.: 13/223,093

(22) Filed: Aug. 31, 2011

(51) Int. Cl. H04R 29/00

(52) U.S. Cl. 381/56

(57) ABSTRACT

Embodiments herein relate to controlling a connection to an interface. In an embodiment, a protection circuit is to detect a voltage at an input rail of a regulator, where the regulator is to provide power to a peripheral device via an interface. Next, the protection circuit is to compare the detected voltage to a reference voltage. Then, the protection circuit is to generate a detection signal based on the comparison. Lastly, the protection circuit is to disable a connection between the regulator and the interface based on the detection signal.

### BACKGROUND

Some types of devices, such as portable electronic devices, may be difficult to operate when a user is simultaneously carrying out other tasks, such as running or driving. For example, a user interface of the device may not be readily usable or reachable by the user.

### BRIEF DESCRIPTION OF THE DRAWINGS

The following detailed description references the drawings, wherein:

FIG. 1 is a diagram of an example detector;

FIG. 2 is another diagram of an example detector;

FIG. 3 is a diagram of an example sound system including the detector of FIG. 2;

FIG. 4A is a diagram of the sound system of FIG. 3 when a sound output device is not tapped;

FIG. 4B is a diagram of the sound system of FIG. 3 when the sound output device is tapped;

FIG. 5 is a diagram of part of an example audio device of FIGS. 3-4B;

FIG. 6 is a scope plot of example inputs to the current detection unit and the voltage detection unit of FIGS. 1, 2 and 5; and

FIG. 7 is a flowchart of an example method for detecting tapping of the sound output device.

### DETAILED DESCRIPTION

Specific details are given in the following description to provide a thorough understanding of embodiments. However, it will be understood by one of ordinary skill in the art that embodiments may be practiced without these specific details. For example, systems may be shown in block diagrams in order not to obscure embodiments in unnecessary detail. In other instances, well-known processes, structures and techniques may be shown without unnecessary detail in order to avoid obscuring embodiments.

Electronic devices, such as portable electronic devices, may be difficult to use when a user is simultaneously involved in an activity, such as running, participating in a sport, driving, using another electronic device, or any other type of activity that diverts the user's attention. For example, a user interface of the device may not be readily usable or reachable by the user and/or the user may not be able to easily view the user interface.

Currently, the user may have to unwillingly stop the present activity in order to use the electronic device, such as if the user stops running to interact with a portable audio device. Some electronic device may provide an additional limited interface that is more easily usable or reachable by the user. However, these types of limited interface may not provide full functionality of the user device and/or still be difficult to use if the user is in constant motion, such as running. Further, some electronic devices, include custom interfaces, such as a headphone with integrated control buttons like play, pause, skip forward, skip backward, etc. However, in this instance, the user is limited to only using the custom interface for the electronic device. Therefore, the user can not user another interface, such as a more generic or higher quality headphone. In addition, providing the custom interface may increase the cost of the electronic device.

Embodiments provide a generally low cost and reliable method and/or device to control an operation of a user device. For example, embodiments may allow the user to control an operation of the user device by tapping on part of a sound output device, such as a diaphragm of an earphone. Thus, the user device may be more easily operated without the user looking at the user device, such as the user tapping the earphone while running. Moreover, a wide array of readily available sound output devices may be used in embodiments, such as a standard, lower cost and/or higher quality set of earphones. Further, a sensitivity to the tapping and/or type of operations carried out by the user device in response to the tapping, may be configurable by the user in embodiments. In addition, the embodiments may be readily integrated into existing electronics devices at a low cost.

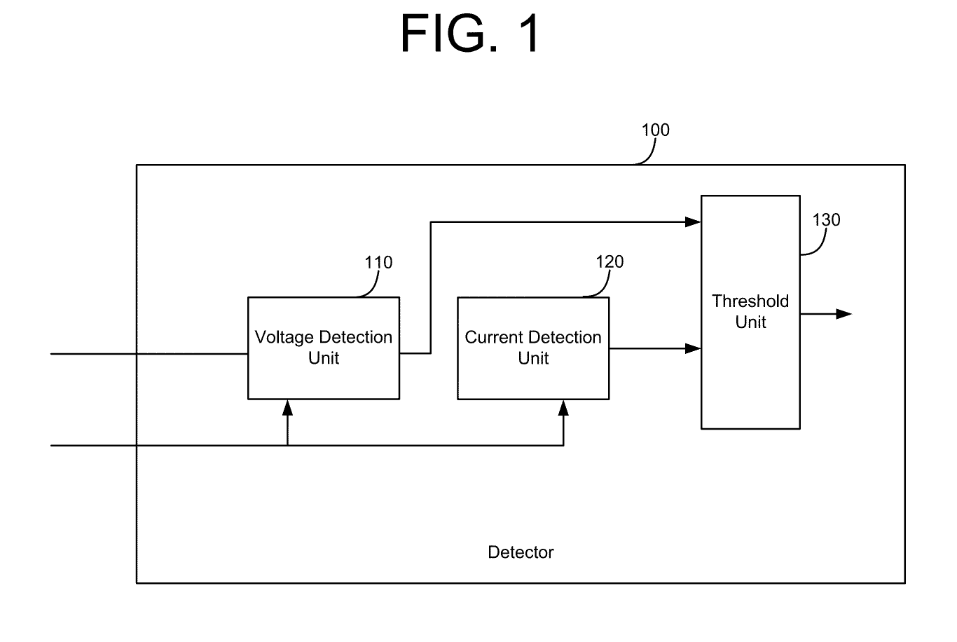

FIG. 1 is a diagram of an example detector 100. The detector 100 may be included in an audio device, such as CD or DVD player, a media or digital audio player, a desktop computer, or a portable device like a digital audio player/mp3 player, mobile phone, personal digital assistant (PDA), etc. In the embodiment of FIG. 1, the detector 100 includes a voltage detection unit 110, a current detection unit 120 and a threshold unit 130.

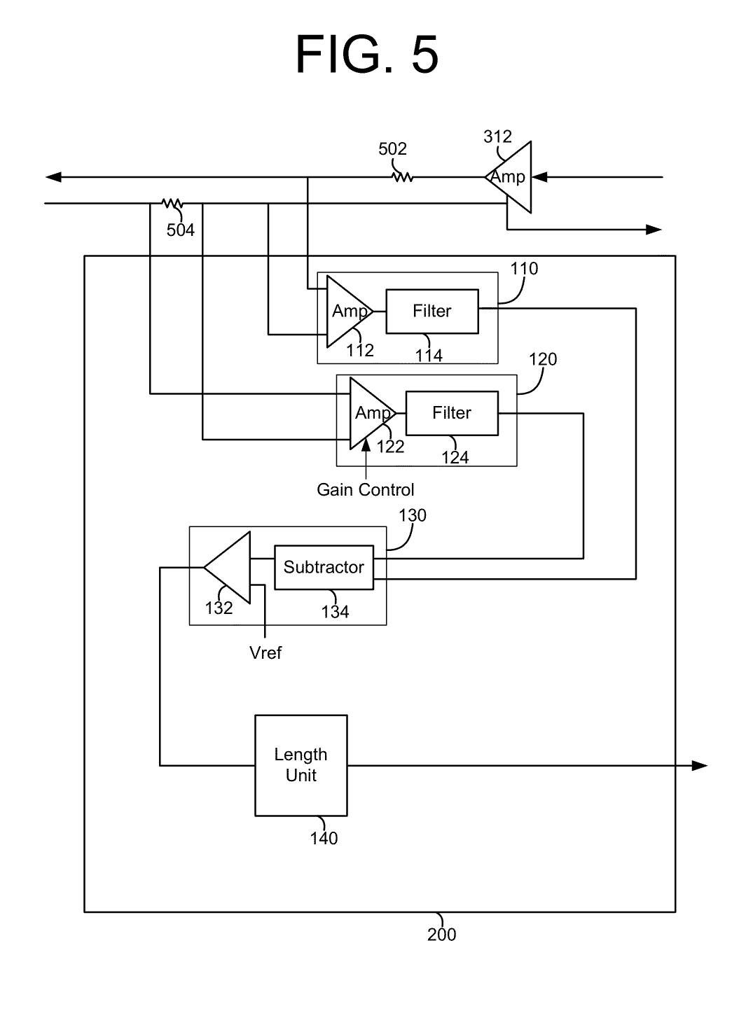

The voltage detection unit 110 is to detect a voltage between a first audio terminal and a second audio terminal of an audio amplifier (not shown) to output an audio signal. The current detection unit 120 is to detect a current along a connection between the first and second audio terminals. The threshold unit 130 is to compare a difference between the detected voltage of the voltage detection unit 110 and the detected current of the current detection unit 120 to a threshold value and to assert a threshold signal based on the comparison. The threshold value is to relate to a voltage generated by a diaphragm of a sound output device (not shown) receiving the audio signal. An example of the components of the detector 100 will be shown in greater detail in FIG. 5 below.

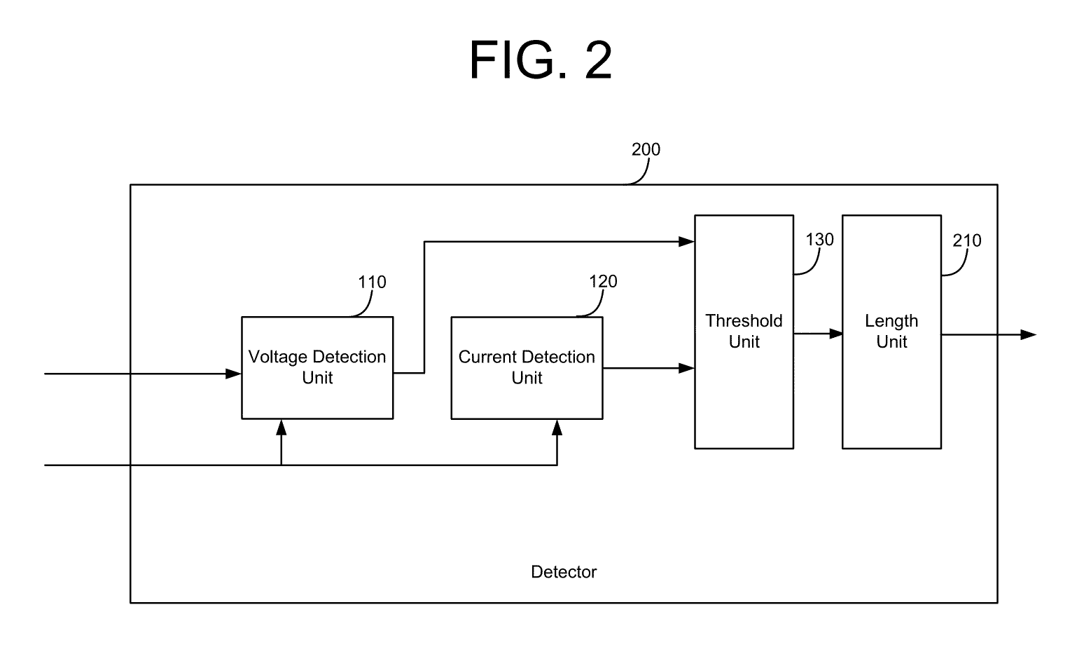

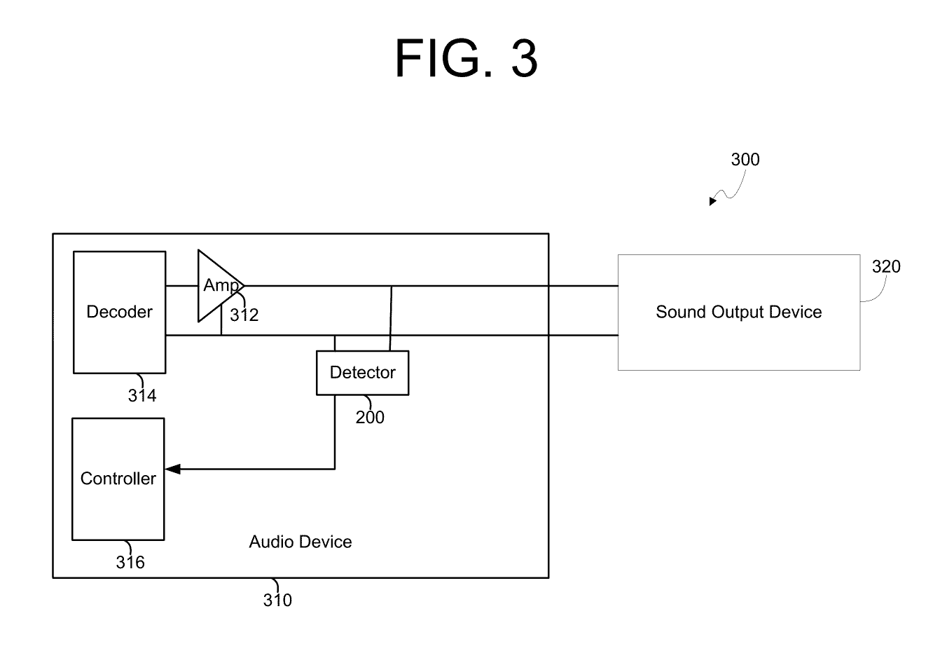

FIG. 2 is another diagram of an example detector 200. Components of the detector 200 of FIG. 2 may be similar to components of the detector 100 of FIG. 1, except the detector 200 of FIG. 2 may also include the length unit 210. The length unit 210 is to compare a time duration of the asserted threshold signal to a reference range. Further, the length unit 210 is to output a pulse if the time duration of the asserted threshold signal is within the reference range. The reference range may relate to a range of times for which the tapped diaphragm would be expected to cause the threshold signal to be asserted. The reference range will be explained in greater detail with respect to FIG. 5.

FIG. 3 is a diagram of an example sound system 300 including the detector 200 of FIG. 2. While the sound system 300 is shown to include the detector 200 of FIG. 2, embodiments may instead also include other suitable devices, such as the detector 100 of FIG. 1. In the embodiment of FIG. 3, the sound system 300 includes an audio device 310 and a sound output device 320.

The audio device 310 includes the detector 200, an audio amplifier 312, an audio source 314 and a controller 316. While the audio device 310 is shown to only connect to the single sound output device 320, embodiments may also include the audio device 310 connecting to a plurality of the sound output devices 320. Thus, while only a single amplifier channel is shown in FIG. 3, embodiments may include a plurality of amplifier channels, such as two amplifier channels if the sound output device 320 is a set of stereo earphones. In such a case, the audio device 320 may also include a plurality of one or more of the detectors 200, the audio amplifiers 312, the audio sources 314 and/or the controllers 316.

The audio source 314 may be any type of device to provide an audio signal to the audio amplifier 312, such as an AM/M tuner, a CD player, a digital-to-analog converter (DAC) and the like. The audio amplifier 312 is to amplify and output the decoded and/or decompressed audio data as an audio signal to the sound output device 320. When the sound output device 320 is connected to the audio device 310 through an interface, such as an audio jack, the amplifier 312 forms a closed loop connection with the sound output device 320 between the first and second audio terminals of the audio amplifier 312. The audio amplifier 320 may include any type of device to increase a power of a signal. The sound output device 320 is a device, such as electroacoustic transducer, to produce sound in response to the audio signal. An example of the sound output device 320 may include one or more speakers, such as headphones or earphones.

As shown in FIG. 3, the detector 200 connects to the first and second audio terminals of the audio amplifier 312 to detect the current and voltage of the sound output device 320. Additionally, the detector 200 outputs the threshold signal to the controller 316.

The controller 316 is to control an operation of the audio device 310 based on a time pattern of the one or more pulses output by the length unit 210. The time pattern may be defined by a number and/or duration of time lapses between the one or more pulses for a given time cycle. The operation controlled by the controller 316 may relate to a volume scale, an audio track selection, a power setting, and the like. For example, a time pattern having a single pulse may be interpreted as a toggle between play/pause functions. Another time pattern including a pause between two pulses may be interpreted as a seek function.

Further, if the audio device 310 is connected to a plurality of the sound output devices 320, then the operation of the audio device 310 may be based on a plurality of the time patterns. For example, a first pattern may be generated from a first sound output device (e.g. a left earphone) and a second pattern may be generated from a second sound output device (e.g. a right earphone). In this case, simultaneously receiving a single pulse from the first pattern and a single pulse from the second pattern may be interpreted as a power off function. Moreover, two pulses in quick succession from the first pattern may be interpreted as skip forward function while two pulses in quick succession from the second pattern may be interpreted as skip backward function.

The above correlations between one or more pattern types and an operation of the audio device 310 merely represent some of many possible example correlations for the audio device 310. Similarly, the above operations merely represent some of the many possible operations to be correlated for the audio device 310. For example, other operations to be correlated may include placing/ending a call, opening a file, powering on the audio device, etc. Further, the correlations between a type of pattern and a type of operation may be configurable by a user via, for example, a user interface (not shown) included in the audio device 310. Embodiments may include the controller 316 to correlate any type of one or more patterns to one or more operations of the audio device 310.

The controller 316 may communicate with a processor (not shown) and/or a memory (not shown) included in the audio device 310, to carry out one or more of the above operations and/or correlations. For example, the controller 316 may communicate with the processor to access the memory. The memory may store a database for associating a type of one or more patterns to a type of operation and/or software to execute one or more types of operations. The processor may also communicate with one more components of the audio device 310 to carry out the correlated operation, such as accessing the audio amplifier 312 to control the volume scale.

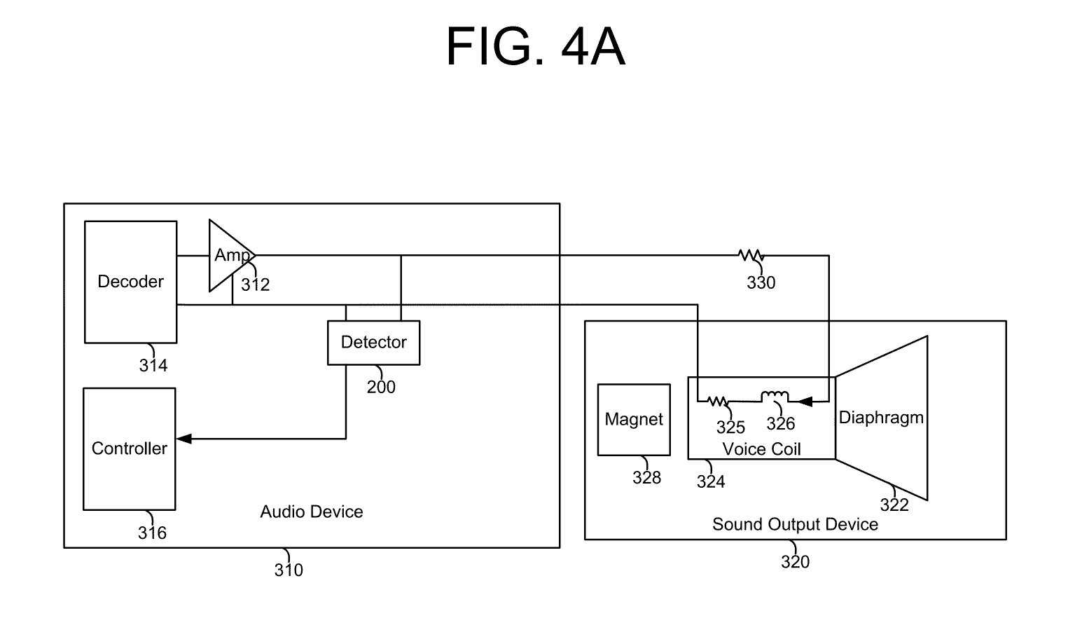

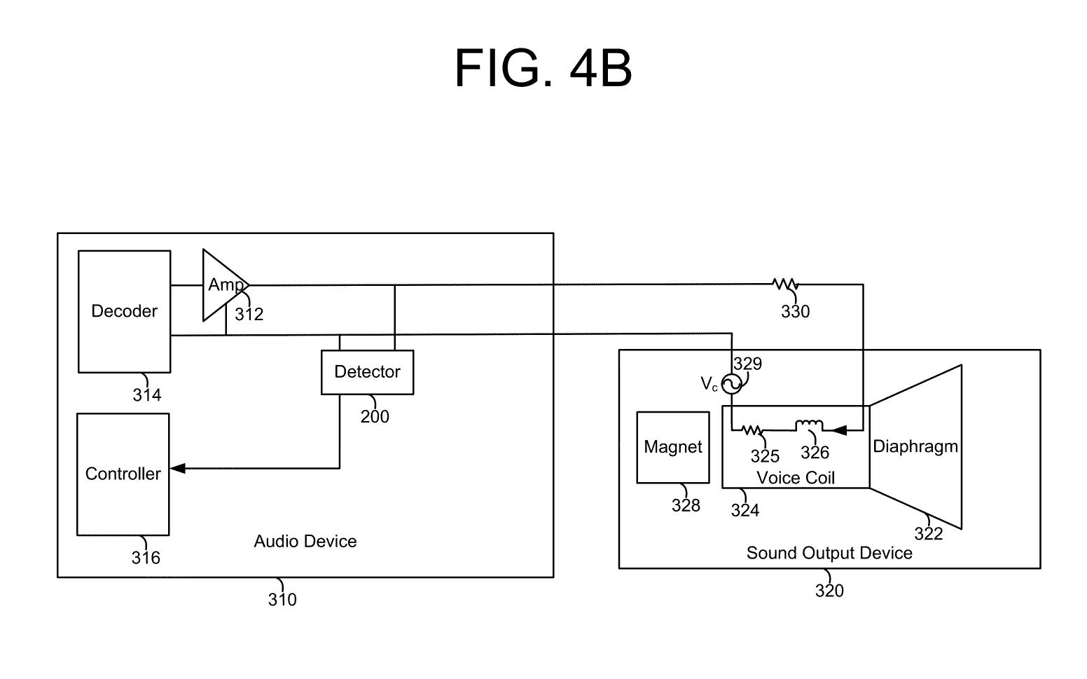

FIG. 4A is a diagram of the sound system 300 of FIG. 3 when the sound output device 320 is not tapped. FIG. 4B is a diagram of the sound system 300 of FIG. 3 when the sound output device 320 is tapped. The audio device 310 in FIGS. 4A and 4B may be similar to that of FIG. 3. In the embodiments of FIGS. 4A and 4B, the sound output device 320 includes a diaphragm 322, a voice coil 324 and a magnet 328. The voice coil 324 further includes a coil resistor 325 representing a resistance of the voice coil 324 and a coil inductor 326 representing an inductance of the voice coil 324. The sound output device 320 may connect to the audio device 310 via a wired connection, such as a cable. The wired connection may have a resistance represented by a connection resistor 330.

In FIGS. 4A and 4B, the diaphragm 322 is attached to the voice coil 324. The voice coil 324 may be able to move somewhat freely back and forth over the magnet 328. The diaphragm 322 may be any type of transducer to convert between mechanical motion and sound. For example, the diaphragm 322 may include a thin, semi-rigid membrane. However, embodiments of the sound output device 322 are not limited to having moving coil drivers.

FIG. 4A shows the sound output device 320 only outputting sound or acting as a speaker. For instance, the audio signal may pass through the voice coil 324, causing an alternating magnetic field that reacts to a static magnetic field of the magnet 328, to vibrate the diaphragm 322 and thus produce sound.

However, as shown in FIG. 4B, the sound output device may also act as a microphone when a user taps the diaphragm 322. The diaphragm 322 may be tapped directly or indirectly. For example, if the sound output device 320 is an earphone or headphone, the diaphragm 322 may be enclosed and/or facing an ear of the user. Therefore, the user may instead tap a casing enclosing the diaphragm 322 or another part of the sound output device 320 to indirectly vibrate the diaphragm 322. In this case, the vibrating diaphragm 322 may cause the attached voice coil 324 to move back and forth over the magnet 328, thus generating a coil voltage V_{c} 329.

The resistance of the connection resistor 330 and the inductance of the coil inductor 326 may be negligible compared to the resistance of the coil resistor 325. For example, in some embodiments, the coil resistor may be between 15 and 33 ohms. Further, in both FIGS. 4A and 4B, an output voltage applied to the sound output device 320 by the audio amplifier 322 may be the same. However, the current along the connection between the audio amplifier 322 and the sound output device 320 may be different among FIGS. 4A and 4B. For example, in FIG. 4B, the current along the connection may generally be greater or lesser by a ratio of the coil voltage V_{c} to the coil resistor 325. Thus, the current along the connection changes when the sound output device 320 is tapped or is used as a microphone. This change in the current along the connection is detected by the detector 200.

FIG. 5 is an example diagram of part of the audio device 310 of FIGS. 3-4B. In this embodiment, the detector is shown to form a connection with the first audio terminal of the audio amplifier 312 and a plurality of connections with the second audio terminal of the audio amplifier 312. A resistance of the audio amplifier 312, as represented by an amplifier resistor 502, may be negligible compared to that of the coil resistor 325.

The detector 200 is shown to include the voltage detection unit 110, the current detection unit 120, the threshold unit 130 and the length unit 140. The voltage detection unit 110 includes a first amplifier 112 and a first filter 114. The first amplifier 112 includes a first input terminal that connects to the first audio terminal of the audio amplifier 312 and a second input terminal that connects to the second audio terminal of the audio amplifier 312. The first amplifier 112 may be a differential amplifier that is to output a first amplifier signal based on amplifying a voltage difference detected between the first audio terminal and the second audio terminal.

The first filter 114 may be a band pass filter to output a first filter signal based on filtering one or more frequencies from the first amplifier signal not related to tapping the diaphragm 322. For example, the first filter 114 may pass frequencies in approximately the 100 Hz to 10 kHz range. As a result, frequencies related to tapping the diaphragm as well as frequencies related to audio signal may pass through. However, frequencies related to false triggering or false tapping of the diaphragm 322, such as those caused by background noise and/or electromagnetic noise, may be filtered.

The current detection unit 120 includes a second amplifier 122 and a second filter 124. The second amplifier 122 includes a first input terminal that connects to the second audio terminal of the audio amplifier 312 and a second input terminal that connects to the second audio terminal of the audio amplifier 312. A current sense resistor 504 may be included along the connection between the first and second input terminals of the second amplifier 122 at the second audio terminal.

The current sense resistor 504 may convert the current along a path between the first and second audio terminals into a voltage. Further, the current sense resistor 504 may have a low value resistance that will have a minimal effect on the output of the audio signal by the audio amplifier 312. The second amplifier 122 may be a differential amplifier that is to output a second amplifier signal based on amplifying a voltage difference detected between a first resistor terminal and a second resistor terminal of the current sense resistor 504.

Further, the second amplifier 122 is shown to receive a gain control signal to match amplitudes of the first and second amplifier signals when the diaphragm 322 is not tapped. The gain control signal may be set by a user or manufacturer and/or by the audio device 310.

The gain control signal may be set to different values for different types of sound output devices 320. For example, different types of earphones may have different resistances. Accordingly, the audio device 310 may allow a user to match the amplitude of the detected current and the detected voltage when the diaphragm 322 is not being tapped. For example, the audio device 310 may include a graphical display and/or user interface that allows the user to align the amplitudes of the first and second amplifier signals. Alternatively, the audio device 310 may detect and align the amplitudes of the first and second amplifier signals automatically.

While the first and second input terminals of the second amplifier 122 and the current sense resistor 504 are shown to connect along the second audio terminal, embodiments may also include the first and second input terminals of the second amplifier 122 and the current sense resistor 504 connecting along the first audio terminal. Further, while the second amplifier 122 is shown to receive the gain control signal, embodiments may include any combination of the first and/or second amplifiers 112 and 122 receiving the gain control signal.

The second filter 124 is to output a second filter signal based on filtering one or more frequencies from the second amplifier signal not related to tapping the diaphragm 322. The second filter 124 may be similar to the first filter 114.

The threshold unit 130 includes a comparator 132 and a subtractor 134. The subtractor 134 is to output a difference signal based on a difference between the first filter signal and the second filter signal. For example, the subtractor 134 may subtract one of the first and second filter signals from another of the first and second filters signals, and then take the absolute value of the subtraction. The difference signal may generally have a value of zero if the diaphragm 322 is not being tapped, due to the amplitudes of the first and second amplifier signals being matched.

The comparator 132 is to assert the threshold signal based on a comparison between the difference signal and a reference voltage signal. For example, the comparator 132 may compare the difference signal output by the subtractor 134 to the reference voltage signal. Then, the comparator 132 may output the threshold signal at a high logic level when the difference signal is greater than the reference voltage. Otherwise, the comparator 132 may output the threshold signal at a low logic level. Embodiments of the comparator 132 may also switch the output of the threshold signal to have the low logic level when the difference signal is greater than the reference voltage and have the high logic level otherwise.

The reference voltage signal relates to a net difference generated between the amplitudes of the detected current and the detected voltage when the diaphragm 322 is tapped. Thus, the reference voltage signal may be set to different values for different types of sound output devices 320. For example, different types of earphones may vary in sensitivity to being tapped and/or generate different amounts of voltage when tapped, such as between 100 to 500 millivolts (mV).

Accordingly, the audio device 310 may allow a user to adjust a value of the reference voltage signal to correlate to a difference in amplitude between the detected current and the detected voltage when the diaphragm 322 is tapped. For example, the audio device 310 may include a graphical display and/or user interface that allows the user to determine an amplitude of the voltage generated by the diaphragm 322 when tapped by the user. Further, the audio device may also the allow the user to set the value of the reference voltage signal based on determined amplitude of the voltage generated by the diaphragm 322, so as to reduce the likelihood of erroneous detection or non-detection of taps to the diaphragm 322. Alternatively, the audio device 310 may set the reference voltage signal automatically upon detecting the amplitude of the voltage generated by the diaphragm 322 when tapped by the user.

As noted above, the length unit 140 is to compare a continuous time duration the threshold signal is asserted to a reference range, where the length unit 140 is to output a pulse if the continuous time duration of the asserted threshold signal is within the reference range. For example, the length unit 140 may output a fixed length output pulse when the continuous time duration of the asserted threshold signal is between a minimum and maximum value, such as between 0.1 milliseconds (ms) and 0.6 ms. Ignoring values outside this reference range may reduce false triggering due to background noise. The pulse may indicate that a tap has occurred to the controller 316 of the audio device 310. The length unit 140 may be implemented via a combination of logic gates.

Embodiments of the detector 200 are not limited to the above configuration. For example, embodiments of the detector 200 may be implemented by a combination of various different analog and/or digital components.

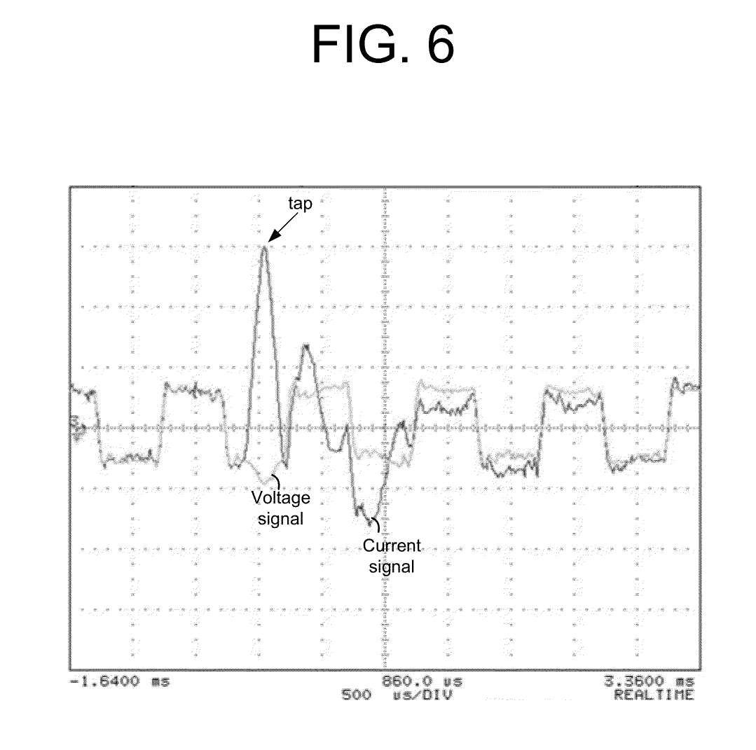

FIG. 6 is a scope plot of example inputs to the current detection unit 110 and the voltage detection unit 120 of FIGS. 1, 2 and 5. In FIG. 6, the gray waveform represents the voltage sensed by the voltage detection unit 110 and the black waveform represents the current sensed by the current detection unit 110. In this example, both the gray and black waveforms are output at one kilohertz (kHz), with the gray waveform being scaled to 10 mV/division and the black waveform being scaled to 30 mV/division.

As shown in FIG. 6, the waveforms of the sensed voltage and current have been adjusted so that they track each other or have a same amplitude when no tapping is occurring, such as at the beginning of the scope plot. However, when a tap occurs, such as at approximately 1.3 ms, the gray waveform for the sensed current increases in amplitude, denoting ringing or vibrating of the diaphragm 322 from the tap. This ringing vibrating of the diaphragm 322 causes the gray or current waveform to temporarily not track or have the same amplitude as the black or voltage waveform. This change in amplitude is detected by the threshold unit 130. Further, a time duration of this change in amplitude may be detected by the length unit 210.

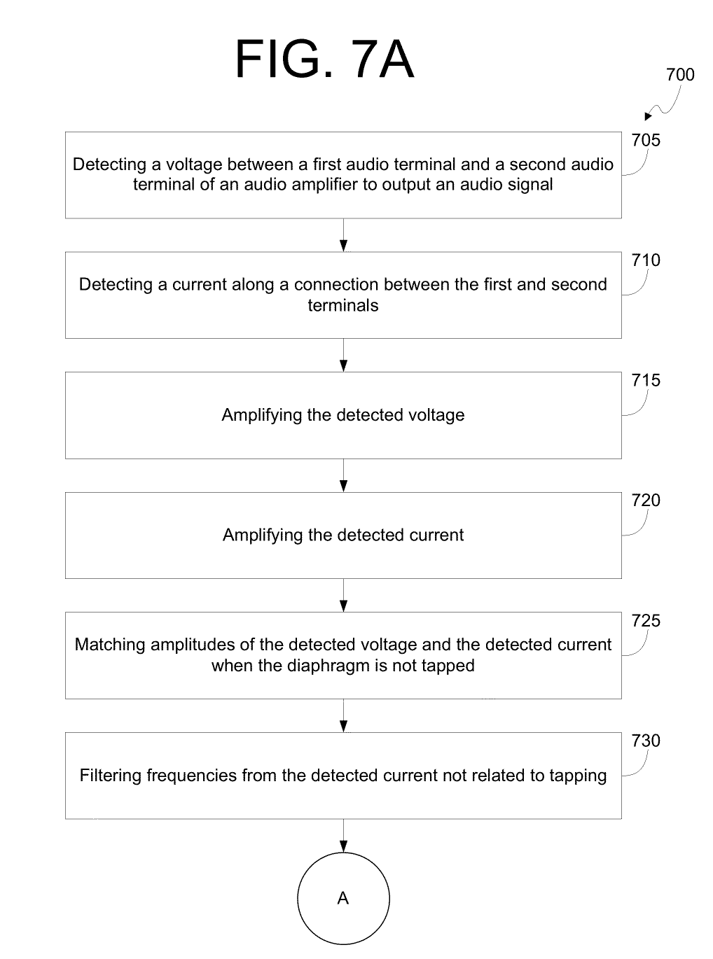

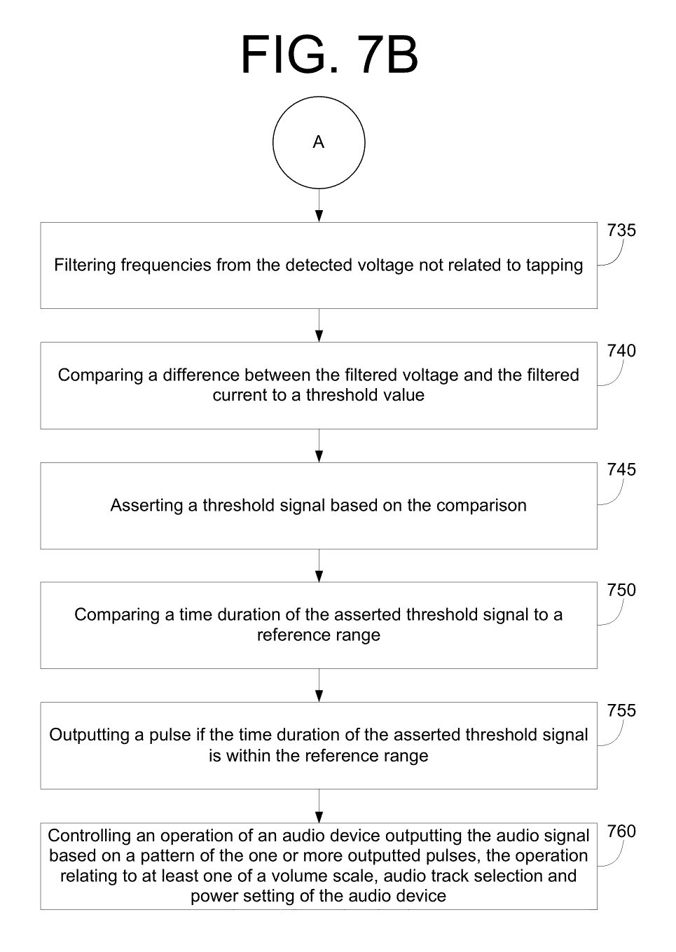

FIGS. 7A-7B are a flowchart of an example method 700 for detecting tapping of the sound output device 320. Although execution of the method 700 is described below with reference to the audio device 310 of FIG. 3, other suitable devices for execution of at least part of the method 700 will be apparent to those of skill in the art. In FIG. 7A, at block 705, the voltage detection unit 110 detects the voltage between the first audio terminal and the second audio terminal of the audio amplifier 312 to output the audio signal. Next, at block 710, the current detection unit 120 detects the current along the connection between the first and second audio terminals. The voltage and current detection at blocks 705 and 710 may be carried out interchangeably and/or simultaneously.

Then, at block 715, the voltage detection unit 110 amplifies the detected voltage, and, at block 720, the current detection unit 120 amplifies the detected current. The voltage and current amplification at blocks 715 and 720 may be carried out interchangeably and/or simultaneously. Next, at block 725, at least one of the voltage detection unit 110 and the current detection unit 120 receives the gain control signal so that the amplitudes of the detected voltage and the detected current match when the diaphragm 322 is not tapped. Further, the matching at block 725 may also be carried out simultaneously with or after at least one of the voltage and current amplification at blocks 715 and 720.

Then, at block 730, the current detection unit 120 filters frequencies from the detected current not related to tapping. Next, flowing to block 735 at FIG. 7B, the voltage detection unit 110 filters frequencies from the detected voltage not related to tapping. The filtering of the detected voltage and current detection at blocks 730 and 735 may be carried out interchangeably and/or simultaneously.

Subsequently, at block 740, the threshold unit 130 compares a difference between the filtered voltage and the filtered current to a threshold value. Next, at block 745, the threshold unit 130 asserts a threshold signal based on the comparison. Then, at block 750, the length unit 210 compares the time duration of the asserted threshold signal to the reference range. Afterward, at block 755, the length unit 210 outputs the pulse if the time duration of the asserted threshold signal is within the reference range. Lastly, at block 760, the controller 316 controls an operation of an audio device 310 outputting the audio signal based on a pattern of the one or more outputted pulses. The operation may relate to a volume scale, audio track selection, power setting and the like, of the audio device 310.

According to the foregoing, embodiments provide a generally low cost and reliable method and/or device to control an operation of a user device, such as an audio device. For example, embodiments may allow the user to control an operation of the user device by tapping on part of a sound output device, such as a diaphragm of an earphone. Thus, the user device may be more easily operated without the user looking at the user device. Moreover, existing sound output devices may be used in embodiments, such as a standard set of earphones. Further, a type of operation carried out by the user device in response to the tapping may be configurable by the user.

We claim:

1. A detector, comprising:
a voltage detection unit to detect a voltage between a first terminal and a second terminal of an amplifier to output an audio signal;
a current detection unit to detect a current along a connection between the first and second terminals; and
a threshold unit to compare a difference between the detected voltage and the detected current to a threshold value and to assert a threshold signal based on the comparison, the threshold value to relate to a voltage generated by tapping a diaphragm of a sound output device receiving the audio signal.

2. The detector of claim 1, further comprising:
a length unit to compare a time duration the threshold signal is asserted to a reference range, wherein
the length unit is to output a pulse if the time duration of the asserted threshold signal is within the reference range.

3. An audio device, comprising:
the detector of claim 2; and
a controller to control an operation of the audio device based on a time pattern of the one or more pulses output by the length unit.

4. The audio device of claim 3, wherein the operation controlled by the controller relates to at least one of a volume scale, audio track selection and power setting of the audio device.

5. The audio device of claim 3, further comprising:
the amplifier to output the audio signal to the sound output device, wherein
the sound output device varies a current detectable by the current detection unit if a user taps the diaphragm of the sound output device.

6. The detector of claim 1, wherein the voltage detection unit includes
a first amplifier to output a first amplifier signal based on a voltage difference between the first amplifier terminal and the second amplifier terminal; and
a first filter to output a first filter signal based on filtering one or more frequencies from the first amplifier signal not related to tapping the diaphragm.

7. The detector of claim 6, wherein the current detection unit includes
a second amplifier to output a second amplifier signal based on a voltage difference between a first resistor terminal and a second resistor terminal of a resistor in series with a path between the first and second amplifier terminals; and
a second filter to output a second filter signal based on filtering one or more frequencies from the second amplifier signal not related to tapping the diaphragm.

8. The detector of claim 7, wherein
at least one of the first and second amplifiers receives a gain control signal to match amplitudes of the first and second filter signals when the diaphragm is not tapped.

9. The detector of claim 1, wherein the threshold unit includes
a subtractor to output a difference signal based on a difference between the first filter signal and the second filter signal; and
a comparator to assert the threshold signal based on a comparison between the difference signal and a reference voltage signal.

10. An audio device, comprising:
an amplifier to output an audio signal via a first terminal and a second terminal;
a detector to compare a voltage and a current along a path between the first and second terminals and to output a pulse if a difference between the voltage and current exceeds a reference value between a threshold range of time, the reference value and the threshold range to relate to voltage generated by tapping a diaphragm of a sound output device receiving the audio signal; and
a controller to control an operation of the audio device based on a pattern of the one or more pulses output by the detector.

11. A method for detecting tapping, comprising:
detecting a voltage between a first terminal and a second terminal of an amplifier to output an audio signal;
detecting a current along a connection between the first and second terminals;
comparing a difference between the detected voltage and the detected current to a threshold value, the threshold value to relate to a voltage generated by tapping a diaphragm of a sound output device receiving the audio signal; and
asserting a threshold signal based on the comparison.

12. The method of claim 11, further comprising:
comparing a time duration of the asserted threshold signal to a reference range; and
outputting a pulse if the time duration of the asserted threshold signal is within the reference range.

13. The method of claim 12, further comprising:
controlling an operation of an audio device outputting the audio signal based on a pattern of the one or more outputted pulses, the operation relating to at least one of a volume scale, audio track selection and power setting of the audio device.

14. The method of claim 11, further comprising:
filtering frequencies from the detected voltage not related to tapping the diaphragm before the comparing; and
filtering frequencies from the detected current not related to tapping the diaphragm before the comparing.

15. The method of claim 14, further comprising:
amplifying the detected voltage before the comparing
amplifying the detected current before the comparing; and
matching amplitudes of the detected voltage and the detected current when the diaphragm is not tapped before the comparing.
